(19) United States
(12) Patent Application Publication
(10) Pub. No.: US 2016/0038934 A1
(43) Pub. Date: Feb. 11, 2016

(54) FLUID ANALYSIS CARTRIDGE AND FLUID ANALYSIS APPARATUS HAVING THE SAME

(71) Applicant: SAMSUNG ELECTRONICS CO., LTD., Suwon-si (KR)

(72) Inventors: Tae Sung GWEON, Osan-si (KR); Chang-Sik KIM, Suwon-si (KR); Hyun-Suk KANG, Suwon-si (KR); Hee Sung CHO, Suwon-si (KR)

(73) Assignee: SAMSUNG ELECTRONICS CO., LTD., Suwon-si (KR)

(21) Appl. No.: 14/753,248

(22) Filed: Jun. 29, 2015

(30) Foreign Application Priority Data
Aug. 8, 2014 (KR) 10-2014-0102476

(51) Int. Cl. B01L 3/00

(52) U.S. Cl. CPC B01L 3/508; B01L 2200/0689; B01L 2300/123

(57) ABSTRACT

A fluid analysis apparatus including: a fluid analysis cartridge comprising a fluid supplying part configured to supply a fluid sample; and a pressing member configured to press and seal the fluid supplying part, wherein the pressing member is configured to couple with the fluid analysis cartridge so that the fluid supplying part is inserted into the pressing member.

### CROSS-REFERENCE TO RELATED APPLICATION

This application claims the benefit of Korean Patent Application No. 10-2014-0102476, filed on Aug. 8, 2014 in the Korean Intellectual Property Office, the disclosure of which is incorporated herein by reference in its entirety.

### BACKGROUND

1. Field

One or more exemplary embodiments relate to a fluid analysis cartridge and a fluid analysis apparatus having the same, and more particularly, to a fluid analysis cartridge having an improved structure capable of enhancing inspection reliability, and a fluid analysis apparatus having the same.

2. Description of the Related Art

An apparatus and method of analyzing a fluid sample is required in various fields, such as environmental monitoring, food inspection, and medical diagnosis. In the related art, to perform an inspection according to predetermined protocols, skilled experimenters must manually perform various processes such as reagent injections, mixing operations, separating and moving operations, reacting operations, and centrifugal separating operations. These manually performed operations can cause errors in an inspection result.

To address this problem, a compact and automated apparatus for rapidly analyzing an inspection material has been developed. In particular, there is a portable fluid analysis cartridge for analyzing a fluid sample and performing various functions in various fields. An advantage of the portable fluid analysis cartridge is that an unskilled person can easily perform an inspection.

However, when a foreign substance is located on a contact portion between a fluid analysis cartridge and a fluid analysis apparatus, a predetermined pressure may not be maintained between the fluid analysis cartridge and the fluid analysis apparatus. Therefore, it may be difficult to inject and inspect a fluid sample. Further, when a crack forms in the fluid analysis cartridge, a loss of pressure through the crack may occur at the contact portion between the fluid analysis cartridge and the fluid analysis apparatus, and this may affect the inspection result.

Therefore, a fluid analysis cartridge and fluid analysis apparatus having an improved structure and function is needed.

### SUMMARY

Therefore, it is an aspect of one or more exemplary embodiments to provide a fluid analysis cartridge having an improved structure which is capable of easily injecting a fluid therein, and a fluid analysis apparatus having the same.

It is another aspect of one or more exemplary embodiments to provide a fluid analysis cartridge having an improved structure which is capable of maintaining a predetermined pressure at a contact portion between the fluid analysis cartridge and a fluid analysis apparatus, and the fluid analysis apparatus having the same.

In accordance with an aspect of one or more exemplary embodiments, there is provided a fluid analysis apparatus including: a fluid analysis cartridge including a fluid supplying part configured to supply a fluid sample; and a pressing member configured to press and seal the fluid supplying part, wherein the pressing member is configured to couple with the fluid analysis cartridge so that the fluid supplying part is inserted into the pressing member.

The fluid supplying part may include a protrusion from the fluid analysis cartridge directed towards the pressing member when the pressing member is coupled with the fluid analysis cartridge, and the pressing member may be configured to couple to the fluid supplying part so as to contact at least one surface of the fluid supplying part.

The pressing member may include at least one rib formed on an inner surface of the pressing member, the at least one rib being configured to contact a side surface of the fluid supplying part when the pressing member is coupled with the fluid analysis cartridge.

The pressing member may include at least one rib formed on an inner surface of the pressing member, the at least one rib being configured to contact an outer circumference of the fluid supplying part when the pressing member is coupled with the fluid analysis cartridge.

The pressing member may include at least one rib formed on an inner surface of the pressing member and protruding inward, and the at least one rib may be configured to contact an outer circumference of the fluid supplying part, when the pressing member is coupled with the fluid analysis cartridge, sealing the fluid supplying part.

The at least one rib may be integrally formed with the pressing member.

The at least one rib may be formed from a flexible material.

The flexible material may be at least one of a rubber and a silicone.

The at least one rib may include: a head connected to the inner surface of the pressing member; and a tail disposed to be in direct contact with an outer surface of the fluid supplying part when the pressing member is coupled with the fluid supplying part. A width of the head may be greater than or equal to a width of the tail.

The tail may include a pointed end.

In accordance with another aspect of an aspect of one or more exemplary embodiments, there is provided a fluid analysis apparatus including: a fluid analysis cartridge including a fluid supplying part configured to supply a fluid sample; and a pressing member configured to couple with the fluid supplying part so as to seal the fluid supplying part, the pressing member including at least one rib disposed on an inner surface of the pressing member and configured to contact a side surface of the fluid supplying part, sealing the fluid supplying part.

The fluid supplying part may include an upward protrusion, an outer surface of the upward protrusion may be a side surface of the fluid supplying part, and the at least one rib may be configured to contact the outer surface when the pressing member is coupled with the fluid supplying part.

The fluid supplying part may include: a base provided on the fluid analysis cartridge and including a seating surface on which the pressing member is seated when the pressing member is coupled with the fluid supplying part; and a body extending upward from the base and including a contact surface. The contact surface may be an outer surface of the upward protrusion, and the at least one rib may be configured to contact the contact surface of the body when the pressing member is coupled with the fluid supplying part.

The contact surface may be provided along an outer circumference of the body.

A width of the base may be greater than a width of the body.

The at least one rib may be formed of at least one of a rubber material and a silicone material.

The at least one rib may be disposed on the inner surface of the pressing member and protrude inward.

When the pressing member is coupled with the fluid supplying part, the at least one rib may be bent in a coupling direction of the pressing member to the fluid supplying part by a process in which the pressing member is coupled to the fluid supplying part.

The at least one rib may include: a head connected to the inner surface of the pressing member; a tail configured to directly contact the side surface of the fluid supplying part when the pressing member is coupled with the fluid supplying part; and a connection part connecting the head and the tail. A width of the tail may be less than or equal to at least one of a width of the head and a width of the connection part.

In accordance with still another aspect of an aspect of one or more exemplary embodiments, there is provided a fluid analysis cartridge configured to be coupled to a pressing member of a fluid analysis apparatus so as to be pressed by the pressing member, the fluid analysis cartridge including: a fluid supplying part configured to supply a fluid sample. The fluid supplying part may protrude upward and gradually incline inward in an upward direction, such that, when the pressing member is coupled with the fluid supplying part, the pressing member is coupled along a side surface of the fluid supplying part.

In accordance with another aspect of an aspect of one or more exemplary embodiments, there is provided a fluid analysis apparatus configured to seal a fluid supplying part of a fluid analysis cartridge, the fluid analysis apparatus including: a pressing member configured to seal the fluid supplying part. The pressing member includes at least one rib disposed on an inner surface of the pressing member and configured to contact a side surface of the fluid supplying part, sealing the fluid supplying part.

In accordance with still another aspect of an aspect of one or more exemplary embodiments, there is provided a fluid analysis cartridge configured to be sealed by a pressing member of a fluid analysis apparatus, the fluid analysis cartridge including: a fluid supplying part configured to supply a fluid sample, the fluid supplying part including: a base including a seating surface on which the pressing member sits when the pressing member seals the fluid supplying part; and a body extending upward from the base and including a contact surface contacted by an inner surface of the pressing member when the pressing member seals the fluid supplying part.

An outer surface of the body may incline inward to the fluid supplying part in an upward direction.

Additional aspects of one or more exemplary embodiments will be set forth in part in the description which follows and, in part, will be obvious from the description, or may be learned by practice of one or more exemplary embodiments

### BRIEF DESCRIPTION OF THE DRAWINGS

These and/or other aspects of one or more exemplary embodiments will become apparent and more readily appreciated from the following description, taken in conjunction with the accompanying drawings of which:

FIG. 1 is a perspective view illustrating an exterior of a fluid analysis apparatus in accordance with an exemplary embodiment;

FIG. 2 is a perspective view illustrating a fluid analysis cartridge in accordance with an exemplary embodiment;

FIG. 3 is an exploded view illustrating an inspection unit of the fluid analysis cartridge in accordance with an exemplary embodiment;

FIG. 4A is a cross-sectional view of the inspection unit of the fluid analysis cartridge of FIG. 2, taken along line A-A′ according to an exemplary embodiment;

FIG. 4B is an enlarged view of portion G of FIG. 4A;

FIG. 5 is a perspective view illustrating a pressing member of the fluid analysis apparatus in accordance with an exemplary embodiment;

FIG. 6A is a cross-sectional view illustrating the pressing member of the fluid analysis apparatus in accordance with an exemplary embodiment;

FIG. 6B is an enlarged view of portion H of FIG. 6A;

FIGS. 7A to 7D are views illustrating various configurations of a rib provided at the pressing member of the fluid analysis apparatus in accordance with one or more exemplary embodiments; and

FIG. 8A is a view illustrating a state before the fluid analysis cartridge is pressed by the pressing member of the fluid analysis apparatus in accordance with an exemplary embodiment;

FIG. 8B is an enlarged view of portion J of FIG. 8A;

FIG. 9A is a view illustrating a state in which the fluid analysis cartridge is pressed by the pressing member of the fluid analysis apparatus in accordance with an exemplary embodiment; and

FIG. 9B is an enlarged view of portion K of FIG. 9A.

### DETAILED DESCRIPTION

Hereinafter, one or more exemplary embodiments will be described in detail with reference to the accompanying drawings. Spatially relative terms, such as “front end,” “rear end,” “lower,” “upper,” “upper end,” “lower end,” and the like, are in reference to the drawings, and a shape and a position of each element are not limited by these terms.

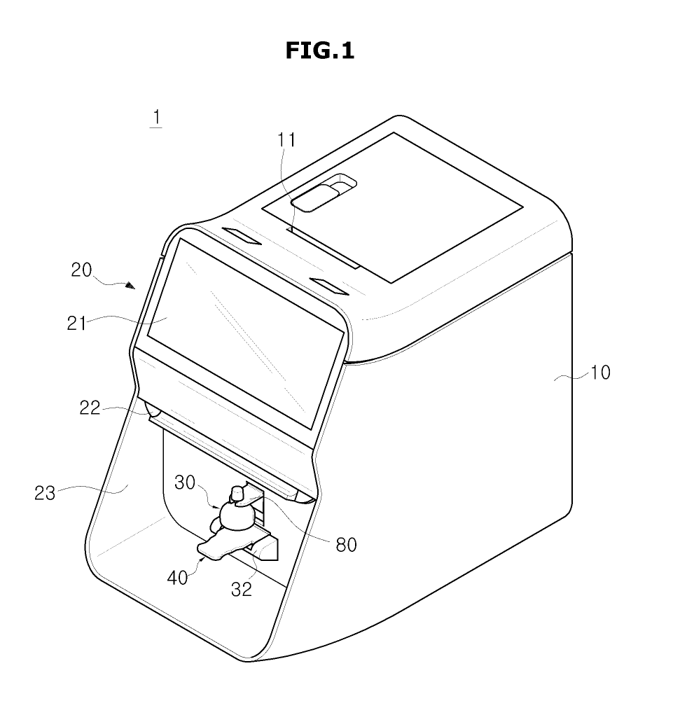

FIG. 1 is a perspective view illustrating an exterior of a fluid analysis apparatus in accordance with an exemplary embodiment.

As illustrated in FIG. 1, the fluid analysis apparatus 1 may include a casing 10 which forms an exterior, and a door module 20 provided on a front portion of the casing 10.

The door module 20 may include a display part 21, i.e., a display, a door 22, and a door frame 23. The display part 21 and the door 22 may be disposed at the front of the door frame 23. The display part 21 may be located above the door 22. The door 22 is slidable. The door 22 may be disposed to the rear of the display part 21, when the door 22 is open.

Information on a sample analysis, an operation state of the sample analysis, and the like may be provided through the display part 21. An installation member 32 in which a fluid analysis cartridge 40 accommodating a fluid specimen (a fluid sample) is installed may be provided within the door frame 23. A user may slide up and open the door 22, install, i.e., insert, the fluid analysis cartridge 40 into the installation member 32, slide down and close the door 22, and then perform an analysis operation.

The fluid analysis apparatus 1 may further include the fluid analysis cartridge 40.

The fluid analysis cartridge 40 may be detachably coupled to the fluid analysis apparatus 1.

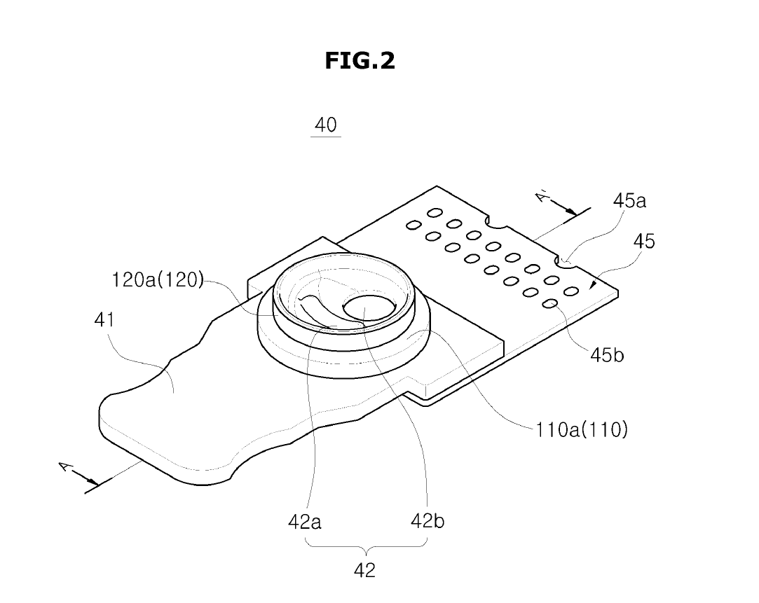

The fluid specimen is injected into the fluid analysis cartridge 40 and then reacts with a reagent at an inspection unit 45 (FIG. 2). The fluid analysis cartridge 40 is installed into the installation member 32 and pressed by a pressing member 30, and thus the fluid specimen in the fluid analysis cartridge 40 may be introduced into the inspection unit 45. The pressing member 30 may be coupled to a lever 80 of the fluid analysis apparatus 1.

The fluid analysis apparatus 1 may further include an output part 11, e.g., a printer, other than the display part 21, which outputs an inspection result in the form of a printed material.

FIG. 2 is a perspective view illustrating the fluid analysis cartridge in accordance with an exemplary embodiment. Hereinafter, reference numerals which are not illustrated refer to FIG. 1.

As illustrated in FIG. 2, the fluid analysis cartridge 40 may be inserted into the installation member 32 of the fluid analysis apparatus 1.

The fluid analysis cartridge 40 may include a housing 41 exterior, and the inspection unit 45 in which the fluid meets and reacts with the reagent.

The housing 41 may support the fluid analysis cartridge 40. Also, the housing 41 may include a grasping part which allows the user to grasp the fluid analysis cartridge 40. The grasping part is formed in a streamlined protrusion shape so as to allow the user to stably grasp the fluid analysis cartridge 40.

Also, a fluid supplying part 42 which supplies the fluid sample may be provided in the fluid analysis cartridge 40. The fluid supplying part 42 may include a supplying hole 42b through which the fluid sample is introduced into the inspection unit 45, and a supply assisting portion 42a which assists the supplying of the fluid. The fluid which is inspected in the fluid analysis apparatus 1 is supplied into the fluid supplying part 42. The fluid may include, for example, a biological sample, such as, as non-limiting examples, urine, saliva, blood, tissue fluid, lymph fluid, and an environmental sample for water quality management and soil management. However, one or more exemplary embodiments are not limited thereto.

The supplying hole 42b may be formed in a circular shape. However, the supplying hole 42b is not limited thereto, and may be formed in a polygonal or partially curved shape. The user may drop the fluid specimen into the fluid supplying part 42 using a tool such as a pipette and a spuit. The supply assisting portion 42a may be formed around the supplying hole 42b and inclined toward the supplying hole 42b. Therefore, the fluid sample dropped around the supplying hole 42b may flow along a slope of the supply assisting portion 42a into the supplying hole 42b. Specifically, when the user does not precisely drop the fluid sample into the supplying hole 42b, some of the fluid sample is dropped around the supplying hole 42b, the fluid sample may be introduced into the supplying hole 42b via the slope of the supply assisting portion 42a.

Further, the supply assisting portion 42a may prevent the fluid analysis cartridge 40 from being contaminated by the erroneously supplied fluid sample, as well as may assist the supplying of the fluid sample. Even when the fluid sample is not precisely dropped into the supplying hole 42b, the supply assisting portion 42a formed around the supplying hole 42b prevents the fluid sample from flowing toward the inspection unit 45 or the grasping part, and thus contamination of the fluid analysis cartridge 40 due to the fluid sample may be prevented. Furthermore, a fluid sample which may be harmful to the human body may be prevented from contacting the user.

The fluid supplying part 42 may include at least one supplying hole 42b. When the fluid supplying part 42 includes a plurality of supplying holes 42b, the inspection with respect to a plurality of fluid samples which are different from each other may be performed in one fluid analysis cartridge 40. Here, the plurality of fluid samples which are different from each other may be a same kind of fluid, but may be from sources, e.g., blood samples from two different people. Alternatively, the kinds of fluids and the sources thereof may be different from each other. Alternatively, the kinds of fluids and the sources thereof may be the same, but the plurality of fluid samples may be in different states.

The fluid supplying part 42 may be formed protruding from the fluid analysis cartridge 40 and thus to face the pressing member 30. Specifically, the fluid supplying part 42 may be formed protruding from the housing 41 of the fluid analysis cartridge 40 and thus faces the pressing member 30, when the fluid analysis cartridge 40 is inserted into the installation member 32. In other words, the fluid supplying part 42 may be formed to protruding upward from the housing 41 of the fluid analysis cartridge 40.

The fluid supplying part 42 may include a base 110 and a body 120.

The base 110 may be disposed on the fluid analysis cartridge 40. The base 110 may be disposed on the housing 41 of the fluid analysis cartridge 40. The base 110 may have a seating surface 110a on which the pressing member 30 may be seated. The seating surface 110a may be provided on an upper surface of the base 110. Also, the seating surface 110a may be provided along a circumference of the body 120.

The body 120 may extend upward from the base 110. The body 120 may have a contact surface 120a with which at least one rib 130 may be in contact, i.e., close contact. The contact surface 120a may be provided along an outer circumference of the body 120. In other words, the contact surface 120a may be provided along a side surface of the body 120. The supplying hole 42b and the supply assisting portion 42a may be provided at the body 120.

The fluid supplying part 42 may have a cylindrical shape. The fluid supplying part 42 may have a shape in which cylinders of different diameters are stacked or overlap. A diameter of the base 110 may be greater than that of the body 120. However, the shape of the fluid supplying part 42 is not limited to the cylinder, and may be modified.

The body 120 may extend from the base 110, stepped in from an outer diameter of the base 110.

A width of the base 110 may be greater than that of the body 120.

The seating surface 110a of the base 110 may be provided at one surface of the base 110 corresponding to an outside of the body 120.

The fluid supply part 42 may be formed gradually inclined inward as the fluid supply part 42 extends upward, such that the pressing member 30 is in contact with a side surface of the fluid supplying part 42. Specifically, the body 120 of the fluid supplying part 42 may be formed to be gradually inclined inward in an upward direction of the fluid supplying part 42, such that the pressing member 30 is disposed along the side surface of the fluid supplying part 42. The pressing member 30 may press the fluid supplying part 42. In other words, the pressing member 30 may be in contact with the fluid supplying part 42 so as to press the fluid supplying part 42. When the pressing member 30 is in contact with the fluid supplying part 42, the fluid supplying part 42 is sealed. Therefore, a pressure is applied to the fluid supplying part 42. The fluid sample is transferred from fluid supplying part 42 to the inspection unit 45 by pressure applied to the fluid supplying part 42. The fluid supplying part 42 may be formed to be gradually inclined inward in the upward direction of the fluid supplying part 42, such that the coupling of the pressing member 30 with the fluid supplying part 42 is performed, when the pressing member 30 is in contact with the fluid supplying part 42.

The housing 41 may be in contact with the fluid sample, while having a shape for implementing a particular function, and thus may be formed of a chemically and biologically inactive material. For example, the housing 41 may be formed of various materials, such as an acrylic material including polymethylmethacrylate (PMMA), a polysiloxane material including polydimethylsiloxane (PDMS), a polyethylene material including polycarbonate (PC), linear low density polyethylene (LLDPE), low density polyethylene (LDPE), medium density polyethylene (MDPE), and high density polyethylene (HDPE), a plastic material including polyvinylalcohol, very low density polyethylene (VLDPE), polypropylene (PP), acrylonitrile butadiene styrene (ABS) and cyclic olefin copolymer (COC), glass, mica, silica, and a semiconductor wafer. However, the above-mentioned materials are just examples, and one or more exemplary embodiments are not limited thereto. Any materials having chemical and biological stability and mechanical machinability may be used as the materials of the housing 41.

The fluid analysis cartridge 40 may be provided so that the inspection unit 45 is coupled thereto or in contact therewith. The fluid injected through the fluid supplying part 42 is introduced into the inspection unit 45, and reacts with the reagent in the inspection unit 45. Accordingly, an inspection may be performed. The inspection unit 45 includes an inspection part 47b, and the inspection part 47b may accommodate the reagent which reacts with the fluid.

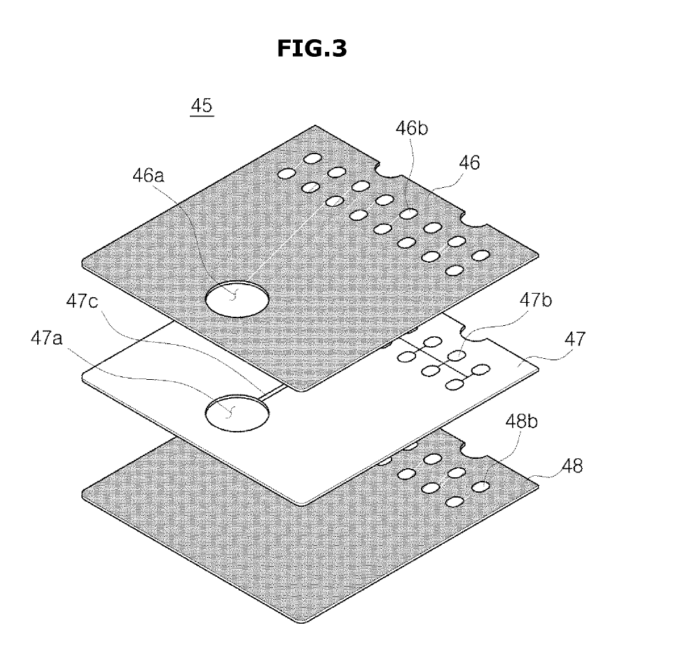

FIG. 3 is an exploded view illustrating the inspection unit of the fluid analysis cartridge in accordance with an exemplary embodiment.

As illustrated in FIG. 3, the inspection unit 45 of the fluid analysis cartridge 40 may have a structure in which three plates 46, 47, and 48 are bonded together. The three plates 46, 47, and 48 may be divided into an upper plate 46, a middle plate 47, and a lower plate 48. The upper plate 46 and the lower plate 48 are light-shielded to protect the fluid sample moving to the inspection part 47b from external light, and to prevent an error which may occur when an optical property is measured in the inspection part 47b. The upper plate 46 and the lower plate 48 may be printed with light-shielding ink.

Each of the upper plate 46 and the lower plate 48 may have a thickness of 10 μm to 30 μm. The middle plate 47 may have a thickness of 50 μm to 300 μm.

A film used to form the upper plate 46 and the lower plate 48 of the inspection unit 45 may be selected from a polyethylene film, a polypropylene (PP) film, a polyvinyl chloride (PVC) film, a polyvinyl alcohol (PVA) film, a polystyrene (PS) film and a polyethylene terephthalate (PET) film formed of very low density polyethylene (VLDPE), linear low density polyethylene (LLDPE), low density polyethylene (LDPE), medium density polyethylene (MDPE), high density polyethylene (HDPE), or the like. However, these films are just examples, and any films having chemical and biological stability and mechanical machinability may be used as the films which form the upper plate 46 and the lower plate 48 of the inspection unit 45.

Unlike the upper plate 46 and the lower plate 48, the middle plate 47 of the inspection unit 45 may be formed of a porous sheet. The porous sheet may be formed of one or more of cellulose acetate, nylon 6.6, nylon 6.10, and polyethersulfone. Since the middle plate 47 is formed of the porous sheet, the middle plate 47 serves as a vent, and also allows the fluid sample to be moved in the inspection unit 45 without a separate driving source. Also, in the case in which the fluid sample has a hydrophilic property, the middle plate 47 may be coated with a hydrophobic solution to prevent the fluid sample from permeating an inside of the middle plate 47.

An inlet port 46a through which the fluid sample is introduced may be formed in the upper plate 46, and an area corresponding to the inspection part 47b may be transparent. An area 48b of the lower plate 48 corresponding to the inspection part 47b may also be transparent. Accordingly, an absorbance of a reaction occurring in the inspection part 47b, i.e., an optical property, may be measured.

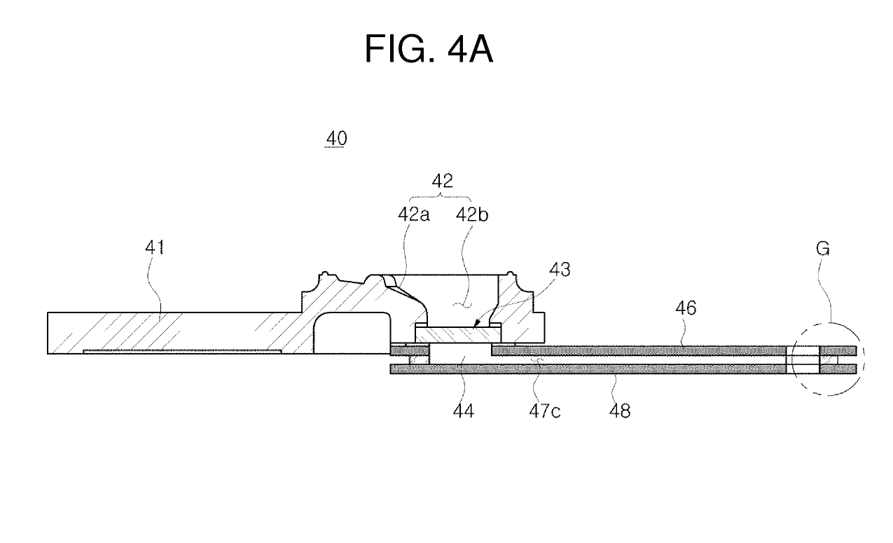

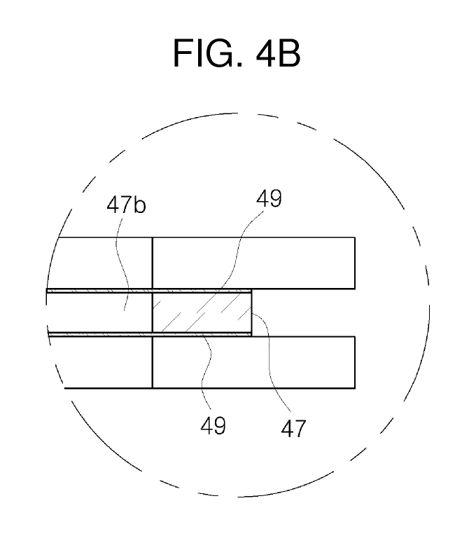

An inlet port 47a through which the fluid sample is introduced may also be formed in the middle plate 47, and the inlet port 46a of the upper plate 46 and the inlet port 47a of the middle plate 47 are overlapped with each other to form an inlet port 44 (FIG. 4A). In the inspection unit 45, various reactions for fluid analysis may occur. In the case in blood is the fluid sample, the reagent which develops a color or is discolored by a reaction with a specific component of the blood (particularly, blood plasma) is accommodated in the inspection part 47b, and the color developed in the inspection part 47b may be optically detected and digitized. Existence and absence of the specific component or a ratio of the specific component in the blood may be checked through a digitized value.

Also, a fluid path 47c which connects the inlet port 47a and the inspection part 47b may be formed in the middle plate 47.

FIG. 4A is a cross-sectional view of the inspection unit of the fluid analysis cartridge of FIG. 2, taken along line A-A′, and FIG. 4B is an enlarged view of portion G of FIG. 4A according to one or more exemplary embodiments.

As illustrated in FIGS. 4A and 4B, the fluid analysis cartridge 40 may be formed in a method in which the inspection unit 45 is bonded to a lower portion of the housing 41. Specifically, the inspection unit 45 may be bonded to a bottom side of the fluid supplying part 42 in which the supplying hole 42b is provided. A pressure sensitive adhesive (PSA) may be used in a bonding operation of the housing 41 and the inspection unit 45. The PSA may be adhere to a target object at room temperature with a small amount of pressure applied for a short time, may be detached without cohesive failure, and may not leave a residue on a surface of the target object. However, the housing 41 and the inspection unit 45 may be bonded by not only the PSA, but may also be bonded using, as a non-limiting example, double-sided adhesive tape or using an insertion method into a groove.

As illustrated in FIGS. 4A and 4B, the fluid sample introduced through the supplying hole 42b passes through a filtering part 43 and then is introduced into the inspection unit 45. The filtering part 43 may be inserted into the supplying hole 42b of the housing 41.

The filtering part 43 may include at least one porous membrane or layer which has a plurality of pores to filter out substances of a predetermined or greater size from the fluid sample. In accordance with one embodiment, the filtering part 43 may include a two-layered filter. For example, a first filter may be formed of glass fiber, non-woven fabric, an absorbent filter, or the like, and a second filter may be formed of polycarbonate (PC), polyethersulfone (PES), polyethylene (PE), polysulfone (PS), polyacrylsulfone (PASF), or the like.

When the filtering part 43 has two layers, the fluid sample passing through an upper layer may be filtered once more by a lower layer. Further, when a large amount of particles larger than the predetermined size are introduced, the filtering part 43 may be prevented from being torn or damaged. However, the filtering part 43 is not limited thereto, but may be formed having three or more layers. Accordingly, a filtering function with respect to the fluid sample is further improved, and stability of the filtering part 43 is increased. Each filtering part 43 may be secured by an adhesive material such as the double-sided adhesive tape.

The inspection unit 45 may include the inlet port 44 through which the fluid sample passing through the filtering part 43 is introduced, the fluid path 47c through which the introduced fluid sample is moved, and the inspection part 47b in which the fluid sample reacts with the reagent.

The upper plate 46, the middle plate 47, and the lower plate 48 may be bonded by a double-sided adhesive tape 49. The double-sided adhesive tape 49 may be attached on upper and lower surfaces of the middle plate 47, and the upper plate 46, the middle plate 47, and the lower plate 48 may be bonded to each other.

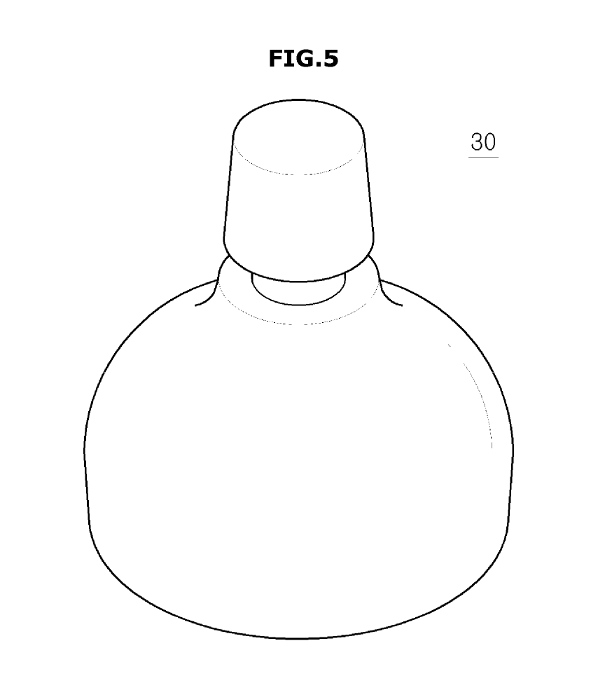

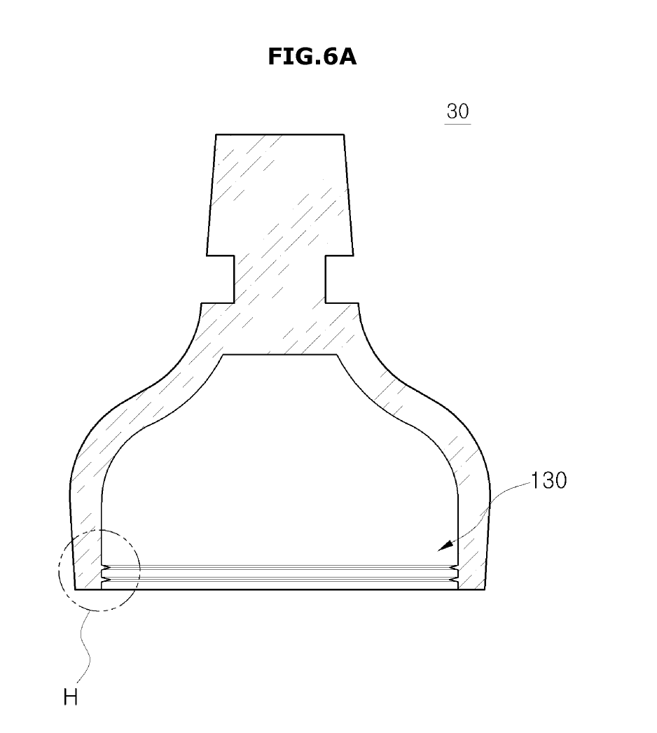

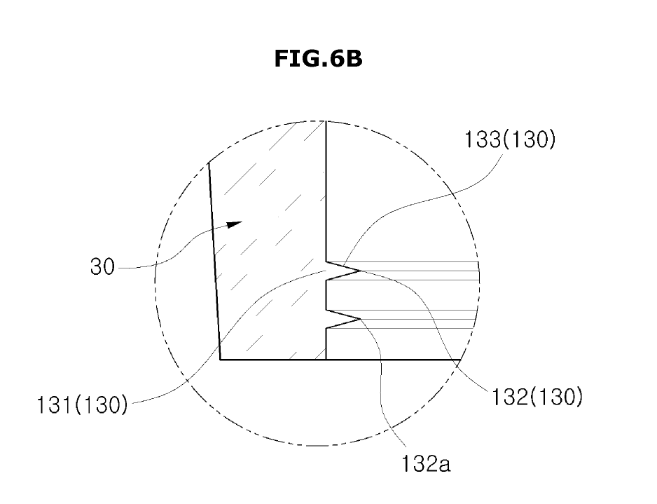

FIG. 5 is a perspective view illustrating the pressing member of the fluid analysis apparatus in accordance with an exemplary embodiment, FIG. 6A is a cross-sectional view illustrating the pressing member of the fluid analysis apparatus in accordance with an exemplary embodiment, and FIG. 6B is an enlarged view of portion H of FIG. 6A.

The pressing member 30 may be in contact with the fluid supplying part 42 so as to seal the fluid supplying part 42. The pressing member 30 may be moved up and down to press the fluid supplying part 42. In another aspect, the pressing member 30 may press the fluid supplying part 42 using the principle of a lever. The pressing member 30 may be coupled to the lever 80. The lever 80 is coupled to a shaft provided in the fluid analysis apparatus 1 so as to be moved up and down. Therefore, the pressing member 30 coupled to the lever 80 may be moved up and down with the lever 80.

The pressing member 30 may be in contact with the fluid analysis cartridge 40 so that the fluid supplying part 42 is inserted into the pressing member 30. Specifically, the pressing member 30 may be in contact with the base 110 of the fluid supplying part 42 so that the body 120 of the fluid supplying part 42 is inserted into the pressing member 30. In a process in which the pressing member 30 is in contact with the fluid analysis cartridge 40, i.e., a process in which the pressing member 30 is in contact with the base 110 of the fluid supplying part 42, one surface of the pressing member 30 may be in close contact with the seating surface 110a of the base 110. Since the pressing member 30 and the fluid supplying part 42 are in contact with each other so that the pressing member 30 covers the fluid supplying part 42, a loss of pressure acting on the fluid supplying part 42 may be reduced. In other words, since the pressing member 30 and the fluid supplying part 42 are in contact with each other so that the pressing member 30 covers the fluid supplying part 42, a sealing effect of the fluid supplying part 42 may be enhanced.

The pressing member 30 may be in contact with the fluid supplying part 42 so as to press at least one surface of the fluid supplying part 42. For example, the pressing member 30 may be in contact with the fluid supplying part 42 to press the seating surface 110a of the base 110. Also, at least one rib 130 of the pressing member 30 may contact the fluid supplying part 42 so as to press the contact surface 120a of the body 120.

The pressing member 30 may be formed of at least one of an elastic material and a flexible material. For example, the pressing member 30 may be formed of a rubber material.

The pressing member 30 may include at least one rib 130.

The at least one rib 130 may be formed at an inner surface of the pressing member 30 so as to be in close contact with the side surface of the fluid supplying part 42. The at least one rib 130 may be formed at the inner surface of the pressing member 30 so as to be in close contact with the outer side surface of the fluid supplying part 42. Specifically, the at least one rib 130 may be formed at the inner surface of the pressing member 30 so as to be in close contact with the contact surface 120a of the body 120.

The at least one rib 130 may be formed at the inner surface of the pressing member 30 so as to be in close contact with the outer circumference of the fluid supplying part 42. Specifically, the at least one rib 130 may be formed at the inner surface of the pressing member 30 so as to be in close contact with an outer circumference of the body 120.

The at least one rib 130 may be formed at the inner surface of the pressing member 30 so as to protrude toward an inside of the pressing member 30.

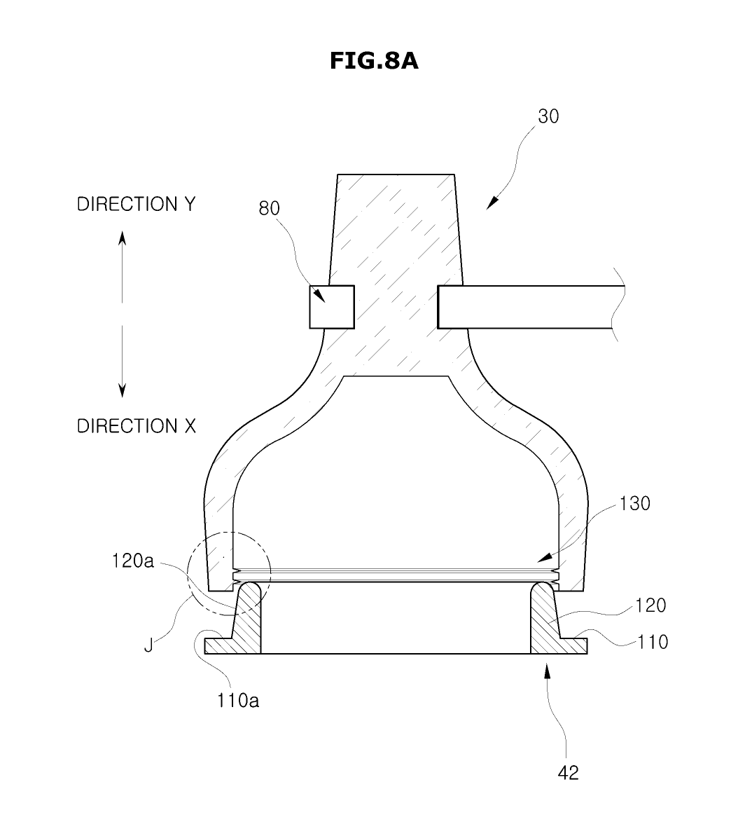

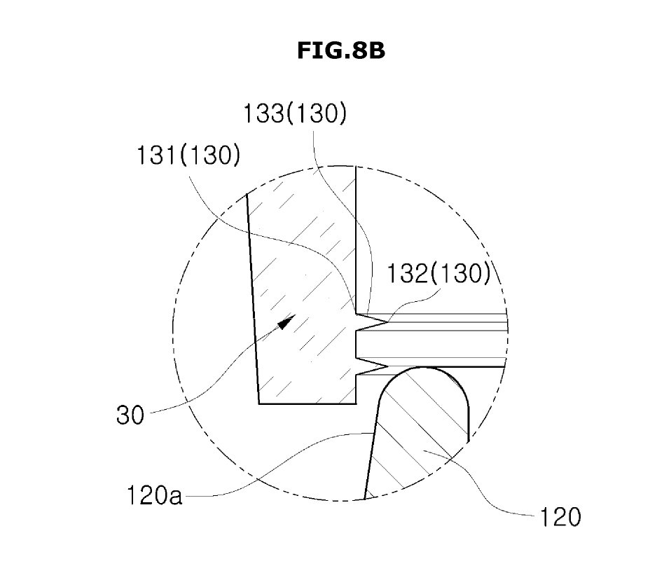

The at least one rib 130 may be bent in a process in which the pressing member 30 and the fluid supplying part 42 are in contact with each other. Specifically, the at least one rib 130 may be bent in a coupling direction X (FIG. 8A) of the pressing member 30 or in a coupling direction Y (FIG. 8A) of the fluid supplying part 42 in the process in which the pressing member 30 is put in contact with the fluid supplying part 42. If the at least one rib 130 includes a plurality of ribs, the ribs may be formed to be spaced apart so as to not interfere with each other when bent.

The at least one rib 130 may be integrally formed with the pressing member 30. The at least one rib 130 may be formed separately from the pressing member 30 and then may be in contact with the pressing member 30.

The at least one rib 130 may include the flexible material.

The at least one rib 130 may include at least one of a rubber material and a silicone material.

The at least one rib 130 may include a head 131 and a tail 132.

The head 131 may be connected to the inner surface of the pressing member 30.

The tail 132 may be connected to the outer surface of the fluid supplying part 42. Specifically, when the pressing member 30 is in contact with the fluid supplying part 42, the tail 132 may be connected to the contact surface 120a of the body 120.

A width of the head 131 may be the same as or greater than that of the tail 132. The width of the head 131 may be greater than that of the tail 132.

The tail 132 may have a sharp end 132a. The sharp end 132a of the tail 132 may have an acute angle, but is not limited thereto.

The at least one rib 130 may further include a connection part 133 which connects the head 131 and the tail 132.

The width of the tail 132 may be the same as that of at least one of the head 131 and the connection part 133, or may be smaller than that of at least one of the head 131 and the connection part 133. Preferably, the width of the tail 132 may be smaller than that of at least one of the head 131 and the connection part 133.

The sealing effect of the fluid supplying part 42 may be further improved by forming at least one rib 130 at the inner surface of the pressing member 30. That is, the at least one rib 130 may block a gap between the pressing member 30 and the fluid supplying part 42 which are in contact with each other, and thus the loss of pressure acting on the fluid supplying part 42 may be effectively reduced.

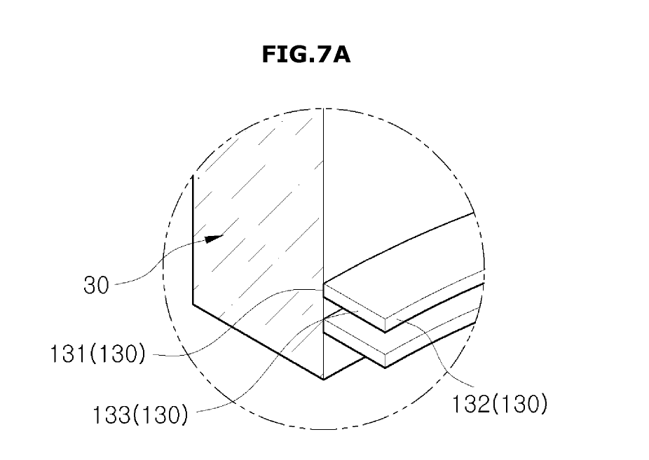

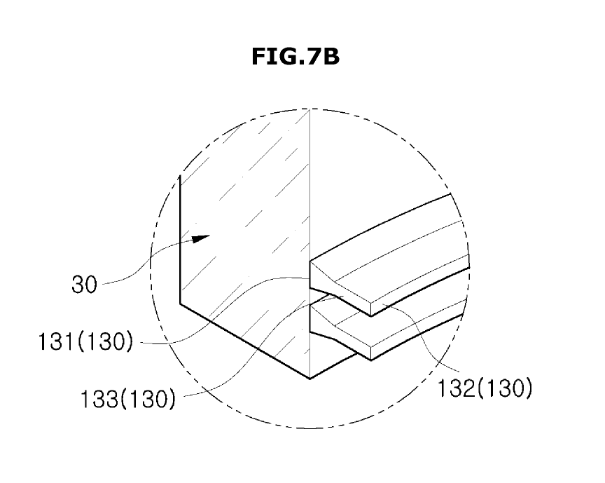

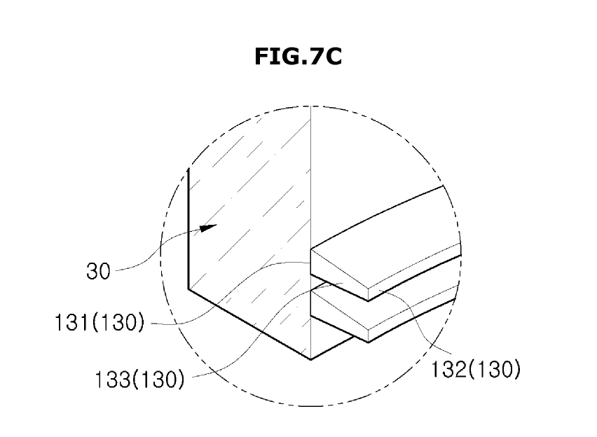

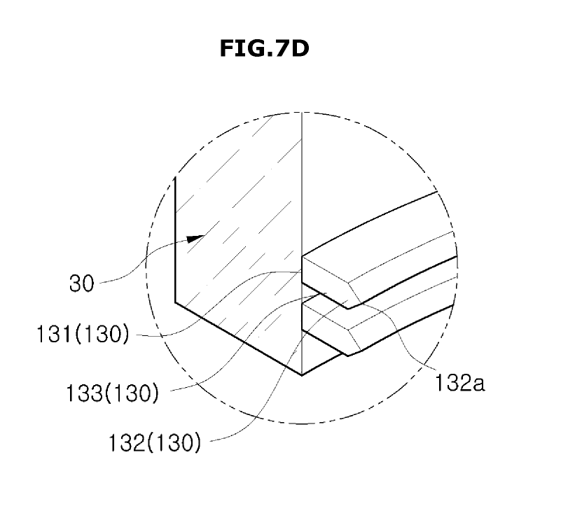

FIGS. 7A to 7D are views illustrating various shapes of the rib provided in the pressing member of the fluid analysis apparatus in accordance with one or more exemplary embodiments.

As illustrated in FIGS. 7A to 7D, the at least one rib 130 may have various shapes.

As illustrated in FIG. 7A, the head 131, the connection part 133, and the tail 132 may have the same width. Also, the at least one rib 130 may have a quadrangular cross section.

As illustrated in FIG. 7B, the width of the head 131 may be greater than those of the connection part 133 and the tail 132. The connection part 133 and the tail 132 may have the same width.

As illustrated in FIG. 7C, the width of the head 131 may be greater than those of the connection part 133 and the tail 132. Also, the tail 132 may not have a sharp end 132a.

As illustrated in FIG. 7D, the width of the head 131 may the same as the connection part 133 and greater than the tail 132. Also, the tail 132 may have the sharp end 132a.

As illustrated in FIGS. 7A to 7D, the at least one rib 130 may have a polygonal cross section. However, a cross-sectional shape of the at least one rib 130 is not limited to the polygonal shape, and may have various shapes such as a circular shape and an elliptical shape.

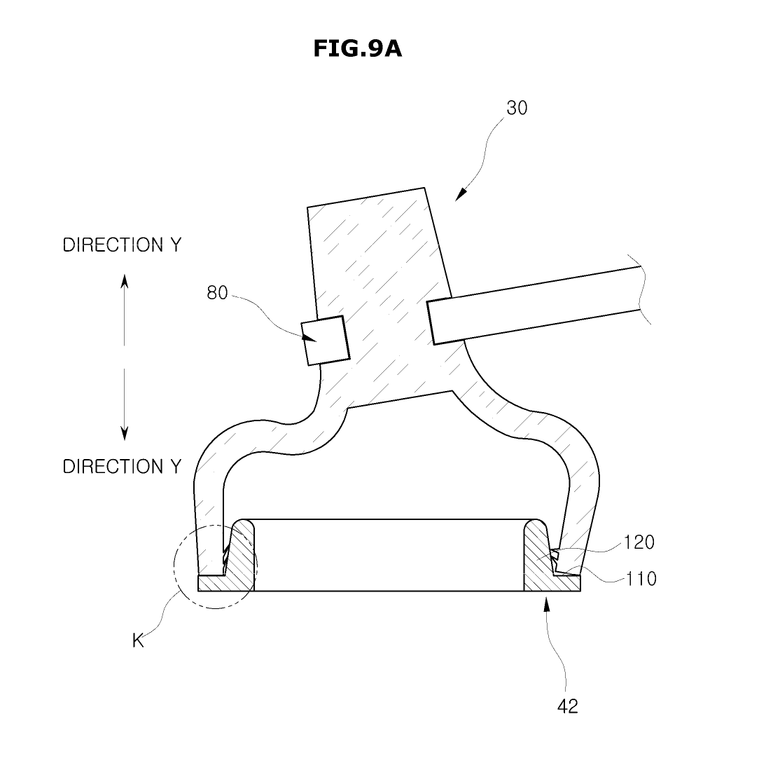

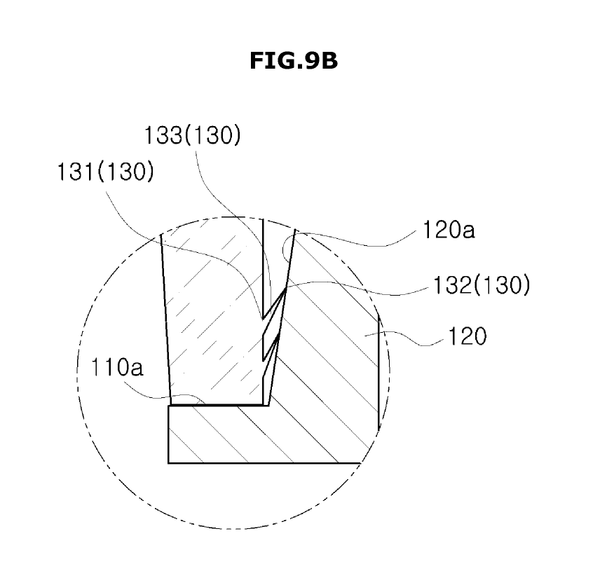

FIG. 8A is a view illustrating the fluid analysis cartridge before being pressed by the pressing member in accordance with an exemplary embodiment, and FIG. 8B is an enlarged view of portion J of FIG. 8A. FIG. 9A is a view illustrating the fluid analysis cartridge pressed by the pressing member in accordance with an exemplary embodiment, and FIG. 9B is an enlarged view of portion K of FIG. 9A.

As illustrated in FIGS. 8A and 9B, the pressing member 30 may be in contact with the fluid supplying part 42, while pressing the fluid supplying part 42. When the lever 80 is moved down about the shaft, the pressing member 30 is integrally moved with the lever 80 and contacted with the fluid supplying part 42. When the pressing member 30 is in contact with the fluid supplying part 42, the pressing member 30 is in close contact with the seating surface 110a of the base 110. Also, the at least one rib 130 provided at the inner surface of the pressing member 30 may be bent in the coupling direction X of the pressing member 30 or in the coupling direction Y of the fluid supplying part 42 in the process in which the pressing member 30 is contacted with the fluid supplying part 42. The at least one rib 130 may be in close contact with the outer surface of the fluid supplying part 42. Specifically, the at least one rib 130 may be in close contact with the contact surface 120a of the body 120. When the pressing member 30 presses the fluid supplying part 42, the close contact between the pressing member 30 and the fluid supplying part 42 occurs at a plurality of portions, and thus a sealed state of the fluid supplying part 42 may be effectively maintained. That is, in the process in which the pressing member 30 presses the fluid supplying part 42, since one end of the pressing member 30 is in close contact with the seating part 110a of the base 110, and the at least one rib 130 is in close contact with the contact surface 120a of the body 120, the loss of pressure acting on the fluid supplying part 42 may be prevented. In other words, the pressing member 30 presses the side surface of the fluid supplying part 42, and thus pressure may be more effectively transmitted to the fluid supplying part 42.

An upper surface of the fluid supplying part 42 is relatively vulnerable to a cracking or a deposit of a foreign substance. Therefore, when the pressing member 30 presses only the upper surface of the fluid supplying part 42, it is difficult to maintain the sealed state of the fluid supplying part 42 due to the crack or the foreign substance. Therefore, the pressing member 30 may press at least one additional surface of the fluid supplying part 42 as well as the upper surface of the fluid supplying part 42, and thus pressure may be effectively transmitted to the fluid supplying part 42.

According to one or more exemplary embodiments, instead of an up/down pressure transmission method of the pressing member with respect to the fluid supplying part, a side pressure transmission method is applied, and thus the loss of pressure acting on the fluid supplying part by the coupling with the pressing member can be prevented.

Also, since at least one rib is formed in the pressing member, the close contact between the pressing member and the fluid supplying part can be increased, and, thus, sealing performance of the fluid supplying part can be enhanced by the contact with the pressing member.

Although a few exemplary embodiments have been shown and described, it would be appreciated by those skilled in the art that changes may be made in these exemplary embodiments without departing from the principles and spirit of the invention, the scope of which is defined in the claims and their equivalents.

What is claimed is:

1. A fluid analysis apparatus comprising:
a fluid analysis cartridge comprising a fluid supplying part configured to supply a fluid sample; and
a pressing member configured to press and seal the fluid supplying part,
wherein the pressing member is configured to couple with the fluid analysis cartridge so that the fluid supplying part is inserted into the pressing member.

2. The fluid analysis apparatus according to claim 1, wherein the fluid supplying part comprises a protrusion from the fluid analysis cartridge directed towards the pressing member when the pressing member is coupled with the fluid analysis cartridge, and
wherein the pressing member is configured to couple to the fluid supplying part so as to contact at least one surface of the fluid supplying part.

3. The fluid analysis apparatus according to claim 1, wherein the pressing member comprises at least one rib formed on an inner surface of the pressing member, the at least one rib being configured to contact a side surface of the fluid supplying part when the pressing member is coupled with the fluid analysis cartridge.

4. The fluid analysis apparatus according to claim 1, wherein the pressing member comprises at least one rib formed on an inner surface of the pressing member, the at least one rib being configured to contact an outer circumference of the fluid supplying part when the pressing member is coupled with the fluid analysis cartridge.

5. The fluid analysis apparatus according to claim 1, wherein the pressing member comprises at least one rib formed on an inner surface of the pressing member and protruding inward to the pressing member, and
wherein the at least one rib is configured to contact an outer circumference of the fluid supplying part, when the pressing member is coupled with the fluid analysis cartridge, thereby sealing the fluid supplying part.

6. The fluid analysis apparatus according to claim 3, wherein the at least one rib is integrally formed with the pressing member.

7. The fluid analysis apparatus according to claim 3, wherein the at least one rib is comprised of a flexible material.

8. The fluid analysis apparatus according to claim 7, wherein the flexible material comprises at least one of a rubber and a silicone.

9. The fluid analysis apparatus according to claim 3, wherein the at least one rib comprises:
a head connected to the inner surface of the pressing member; and
a tail disposed to be in direct contact with an outer surface of the fluid supplying part when the pressing member is coupled with the fluid supplying part, and
wherein a width of the head is the greater than or equal to a width of the tail.

10. The fluid analysis apparatus according to claim 9, wherein the tail comprises a pointed end.

11. A fluid analysis apparatus comprising:
a fluid analysis cartridge comprising a fluid supplying part configured to supply a fluid sample; and
a pressing member configured to couple with the fluid supplying part so as to seal the fluid supplying part, the pressing member comprising at least one rib disposed on an inner surface of the pressing member and configured to contact a side surface of the fluid supplying part, thereby sealing the fluid supplying part.

12. The fluid analysis apparatus according to claim 11, wherein the fluid supplying part comprises an upward protrusion,
wherein an outer surface of the upward protrusion is a side surface of the fluid supplying part, and
wherein the at least one rib is configured to contact the outer surface when the pressing member is coupled with the fluid supplying part.

13. The fluid analysis apparatus according to claim 12, wherein the fluid supplying part comprises:
a base provided on the fluid analysis cartridge and comprising a seating surface on which the pressing member is seated when the pressing member is coupled with the fluid supplying part; and
a body extending upward from the base and comprising a contact surface,
wherein the contact surface is an outer surface of the upward protrusion, and
wherein the at least one rib is configured to contact the contact surface of the body when the pressing member is coupled with the fluid supplying part.

14. The fluid analysis apparatus according to claim 13, wherein the contact surface is provided along an outer circumference of the body.

15. The fluid analysis apparatus according to claim 12, wherein a width of the base is greater than a width of the body.

16. The fluid analysis apparatus according to claim 11, wherein the at least one rib is comprised of at least one of a rubber material and a silicone material.

17. The fluid analysis apparatus according to claim 11, wherein the at least one rib is disposed on the inner surface of the pressing member and protrudes inward to the pressing member.

18. The fluid analysis apparatus according to claim 11, wherein, when the pressing member is coupled with the fluid supplying part, the at least one rib is bent in a coupling direction of the pressing member to the fluid supplying part by a process in which the pressing member is coupled to the fluid supplying part.

19. The fluid analysis apparatus according to claim 11, wherein the at least one rib comprises:
a head connected to the inner surface of the pressing member;
a tail configured to directly contact the side surface of the fluid supplying part when the pressing member is coupled with the fluid supplying part; and
a connection part connecting the head and the tail, and
wherein a width of the tail is less than or equal to at least one of a width of the head and a width of the connection part.

20. A fluid analysis cartridge configured to be coupled to a pressing member of a fluid analysis apparatus so as to be pressed by the pressing member, the fluid analysis cartridge comprising:
a fluid supplying part configured to supply a fluid sample,
wherein the fluid supplying part protrudes upward and gradually inclines inward to the fluid supplying part in an upward direction, such that, when the pressing member is coupled with the fluid supplying part, the pressing member is coupled along a side surface of the fluid supplying part.

21. A fluid analysis apparatus configured to seal a fluid supplying part of a fluid analysis cartridge, the fluid analysis apparatus comprising:
a pressing member configured to seal the fluid supplying part,
wherein the pressing member comprises at least one rib disposed on an inner surface of the pressing member and configured to contact a side surface of the fluid supplying part, thereby sealing the fluid supplying part.

22. A fluid analysis cartridge configured to be sealed by a pressing member of a fluid analysis apparatus, the fluid analysis cartridge comprising:
a fluid supplying part configured to supply a fluid sample, the fluid supplying part comprising:
a base comprising a seating surface on which the pressing member sits when the pressing member seals the fluid supplying part; and
a body extending upward from the base and comprising a contact surface contacted by an inner surface of the pressing member when the pressing member seals the fluid supplying part.

23. The fluid analysis cartridge according to claim 22, wherein an outer surface of the body inclines inward to the fluid supplying part in an upward direction.
